(19) United States
(12) Patent Application Publication
(10) Pub. No.: US 2013/0141229 A1
(43) Pub. Date: Jun. 6, 2013

(54) EASY-TO-USE TIRE PRESSURE MONITORING DEVICE

(71) Applicants: San-Chuan YU, Changhua County (TW); Chao-Ching HU, Tainan City (TW); Tsan-Nung WANG, Changhua County (TW)

(72) Inventors: San-Chuan YU, Changhua County (TW); Chao-Ching HU, Tainan City (TW); Tsan-Nung WANG, Changhua County (TW)

(21) Appl. No.: 13/367,874

(22) Filed: Feb. 7, 2012

(30) Foreign Application Priority Data
Dec. 5, 2011 (TW) 100144682

(51) Int. Cl. B60C 23/02

(52) U.S. Cl. 340/442

(57) ABSTRACT

An easy-to-use tire pressure monitoring device includes a housing having an air valve at one end thereof, and a circuit board mounted inside the housing and carrying a processor and memory unit, a pressure sensor electrically coupled to the processor and memory unit, a temperature sensor electrically coupled to the processor and memory unit, an acceleration sensor electrically coupled to the processor and memory unit, a low-frequency transmitter interface and a radio-frequency transmitter interface electrically coupled to the processor and memory unit, a battery pack and a trigger sensor coupled to the air valve and the processor and memory unit.

### BACKGROUND OF THE INVENTION

1. Field of the Invention

The present invention relates to a tire pressure monitoring technology and more particularly, to an easy-to-use tire pressure monitoring system.

2. Description of the Related Art

The learning mode of a tire pressure monitoring system enables the on-vehicle head unit to memorize the identification codes of the four tires of the motor vehicle, so that the on-vehicle head unit can recognize the data of the tires subject to their identification codes and display the temperature, pressure and other data of each respective tire. In case of any tire abnormality, the on-vehicle head unit can display a corresponding warning signal subject to the respective identification code. After installation of a tire sensor in a tire of a motor vehicle, a learning procedure shall be initiated. The learning mode of conventional tire pressure monitoring systems may be initiated automatically or manually. To a tire pressure monitoring system with manually initiated learning mode, the on-vehicle head unit must be set to enter the learning mode, and then the tire pressure sensors of the four tires are driven to transmit a wireless identification signal to the on-vehicle head unit in a predetermined order, for example, the order of front-right, front-left, rear-left and rear-right, enabling the on-vehicle head unit to memorize the identification code of each of the four tires. Conventionally, a magnet or low frequency setting tool, or a tire pressure-discharging method may be used to trigger the tire pressure sensor of each tire in transmitting a wireless identification signal. However, because a person cannot get a magnet or low frequency setting tool easily anywhere, the method of using a magnet or low frequency setting tool for triggering a tire pressure sensor is not practical. Triggering a tire pressure sensor to transmit a wireless identification signal by discharging the tire pressure of the tire does not require any tool. However, the tire must be inflated to the original standard value after triggering. Thus, this method is complicated.

### SUMMARY OF THE INVENTION

The present invention has been accomplished under the circumstances in view. It is the main object of the present invention to provide an easy-to-use tire pressure monitoring device, which can be directly triggered to transmit a wireless signal to an on-vehicle head unit when it is being installed in a tire of a motor vehicle.

To achieve this and other objects of the present invention, an easy-to-use tire pressure monitoring device comprises a housing having an air valve at one end thereof, and a circuit board mounted inside the housing. The circuit board comprises a processor and memory unit, a pressure sensor electrically coupled to the processor and memory unit, a temperature sensor electrically coupled to the processor and memory unit, an acceleration sensor electrically coupled to the processor and memory unit, a low-frequency transmitter interface and a radio-frequency transmitter interface electrically coupled to the processor and memory unit, a battery pack and a trigger sensor coupled to the air valve and the processor and memory unit. When the air valve is touched by a human body during installation, the trigger sensor provides a trigger pulse signal to the processor and memory unit, causing the easy-to-use tire pressure monitoring device to transmit a wireless identification signal to an on-vehicle head unit.

### BRIEF DESCRIPTION OF THE DRAWINGS

FIG. 1 is a circuit block diagram of an easy-to-use tire pressure monitoring device in accordance with the present invention.

### DETAILED DESCRIPTION OF THE INVENTION

The advantages and features of the present invention will be fully understood by reference to the following two examples in conjunction with the accompanying drawings.

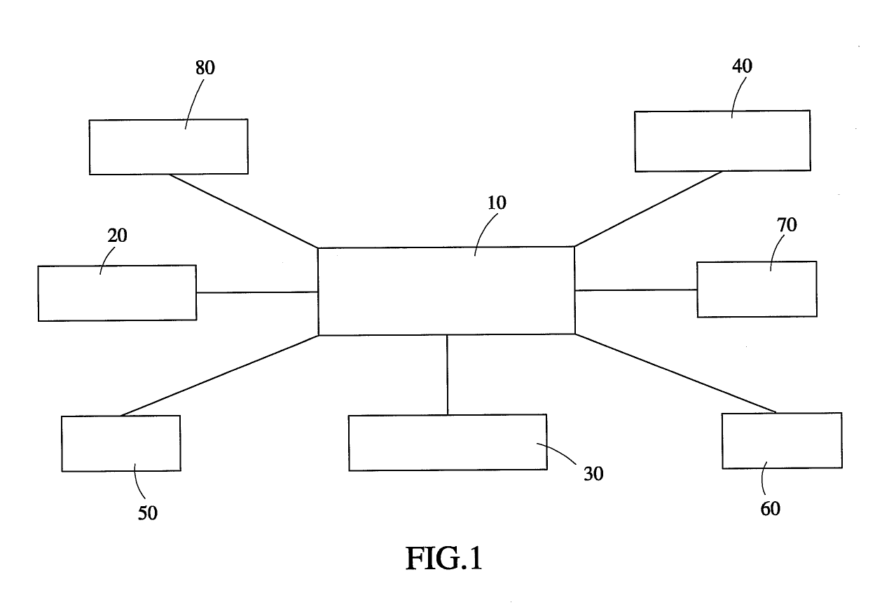

Referring to FIG. 1, an easy-to-use tire pressure monitoring device in accordance with the present invention is shown. The easy-to-use tire pressure monitoring device comprises a housing, an air valve located on one end of the housing, and a circuit board mounted inside the housing. The circuit board has built therein a processor and memory unit 10, a pressure sensor 20 electrically coupled to the processor and memory unit 10 for sensing the internal pressure of a vehicle tire, a temperature sensor 30 electrically coupled to the processor and memory unit 10 for sensing the internal temperature of the vehicle tire, an acceleration sensor 40 electrically coupled to the processor and memory unit 10 for sensing acceleration of the vehicle tire, a low-frequency transmitter interface 50 and a radio-frequency transmitter interface 60 respectively electrically coupled to the processor and memory unit 10 for transmitting the sensed data to an on-vehicle receiver by a low frequency or radio frequency, a battery pack 70 electrically coupled to the processor and memory unit 10 for providing the programmable easy-to-use tire pressure monitoring device with the necessary working power supply, and a trigger sensor 80 electrically coupled to the air valve and the processor and memory unit 10.

During application, the easy-to-use tire pressure monitoring device is installed in a vehicle tire. When a human body touches the air valve of the easy-to-use tire pressure monitoring device, the trigger sensor provides a trigger pulse signal to the processor and memory unit, causing the easy-to-use tire pressure monitoring device to transmit a wireless identification signal to an on-vehicle head unit. To prevent external signal interference or false triggering, a noise removal algorism may be added to the processor and memory unit. Further, the trigger sensor can be a press button switch kept in contact with the air valve. Alternatively, the trigger sensor can be a touch switch electrically coupled with the air valve.

When installing the easy-to-use tire pressure monitoring device in a new vehicle tire or when the on-vehicle head unit is controlled to start learning again, it is not necessary to use a low-frequency setting tool or magnet, or a tire pressure discharging method, for triggering the easy-to-use tire pressure monitoring device to transmit an identification signal to the on-vehicle head unit. The user simply needs to touch the air valve of the easy-to-use tire pressure monitoring device physically. When the user touches the air valve, the processor and memory unit of the easy-to-operate tire pressure monitoring device will be immediately trigged to transmit an identification signal to the on-vehicle head unit wirelessly after a noise removal algorism process. This method of use is quite simple, saving much labor and time.

Although a particular embodiment of the invention has been described in detail for purposes of illustration, various modifications and enhancements may be made without departing from the spirit and scope of the invention. Accordingly, the invention is not to be limited except as by the appended claims.

1. An easy-to-use tire pressure monitoring device mounted in a vehicle tire of a motor vehicle for monitoring the tire pressure of said vehicle tire, comprising:
a housing,
an air valve located on one end of said housing, and
a circuit board mounted inside said housing, said circuit board comprising,
a processor and memory unit,
a pressure sensor electrically coupled to said processor and memory unit for sensing the internal pressure of said vehicle tire,
a temperature sensor electrically coupled to said processor and memory unit for sensing the internal temperature of said vehicle tire,
an acceleration sensor electrically coupled to said processor and memory unit for sensing acceleration of said vehicle tire,
a low-frequency transmitter interface and a radio-frequency transmitter interface respectively electrically coupled to said processor and memory unit for transmitting the sensed data to an on-vehicle receiver in said motor vehicle by a low frequency or radio frequency,
a battery pack electrically coupled to said processor and memory unit for providing the easy-to-use tire pressure monitoring device with the necessary working power supply, and
a trigger sensor coupled to said air valve and said processor and memory unit,
wherein said trigger sensor is a push button switch kept in physical contact with said air valve and said trigger sensor provides a trigger pulse signal to said processor and memory unit for causing the easy-to-use tire pressure monitoring device to transmit a wireless identification signal to an on-vehicle head unit in said motor vehicle.

2. (canceled)

3. (canceled)

4. (canceled)

5. An easy-to-use tire pressure monitoring device mounted in a vehicle tire of a motor vehicle for monitoring the tire pressure of said vehicle tire, comprising:
a housing,
an air valve located on one end of said housing, and
a circuit board mounted inside said housing, said circuit board comprising,
a processor and memory unit,
a pressure sensor electrically coupled to said processor and memory unit for sensing the internal pressure of said vehicle tire,
a temperature sensor electrically coupled to said processor and memory unit for sensing the internal temperature of said vehicle tire,
an acceleration sensor electrically coupled to said processor and memory unit for sensing acceleration of said vehicle tire,
a low-frequency transmitter interface and a radio-frequency transmitter interface respectively electrically coupled to said processor and memory unit for transmitting the sensed data to an on-vehicle receiver in said motor vehicle by a low frequency or radio frequency,
a battery pack electrically coupled to said processor and memory unit for providing the easy-to-use tire pressure monitoring device with the necessary working power supply, and
a trigger sensor coupled to said air valve and said processor and memory unit,
wherein said trigger sensor is a touch switch electrically coupled with said air valve and said trigger sensor provides a trigger pulse signal to said processor and memory unit for causing the easy-to-use tire pressure monitoring device to transmit a wireless identification signal to an on-vehicle head unit in said motor vehicle.

6. The easy-to-use tire pressure monitoring device as claimed in claim 1, wherein the trigger pulse signal is activated without the use of an external device.

7. The easy-to-use tire pressure monitoring device as claimed in claim 5, wherein the trigger pulse signal is activated without the use of an external device.
